(19) United States
(12) Patent Application Publication
(10) Pub. No.: US 2026/0259243 A1
(43) Pub. Date: Sep. 3, 2026

(54) FLUID REMOVAL FOR FLUID SAMPLE PROCESSING SYSTEMS

(71) Applicant: Correlia Biosystems, Inc., Berkeley, CA (US)

(72) Inventors: Samuel Quinn Tia, Berkeley, CA (US); M. Kursad Araz, El Cerrito, CA (US); Robert Ray, Oakland, CA (US); Akwasi A. Apori, Oakland, CA (US)

(21) Appl. No.: 18/879,636

(22) PCT Filed: Jun. 27, 2023
(86) PCT No.: PCT/US2023/026376

§ 371 Date: Dec. 27, 2024

Related U.S. Application Data
(60) Provisional application No. 63/355,998, filed on Jun. 27, 2022.

(51) Int. Cl. G01N 35/10; G01N 35/00

(52) U.S. Cl. CPC G01N 35/1065; G01N 35/0099

(57) ABSTRACT

An apparatus configured for the removal of fluids within a fluid sample processing system can include an aspiration arm, a manifold component, and a vacuum conduit. The aspiration arm can be configured to facilitate the delivery of a vacuum to one or more devices arranged into one or more rows, and the device(s) can include one or more wells configured to hold fluid therein. The manifold component can be coupled to the aspiration arm and can include a set of multiple fluid transmitting extensions configured to be inserted simultaneously into the one or more wells. The vacuum conduit can be coupled to the manifold component and can be configured to deliver vacuum to and aspirate fluids from the one or more wells. The apparatus can be manually operated and/or can be robotically operated by coupling the aspiration arm to a fluid handling robot.

### CROSS-REFERENCE TO RELATED APPLICATIONS

This application claims the benefit of provisional U.S. Patent Application No. 63/355,998, filed Jun. 27, 2022, which is hereby incorporated by reference in its entirety.

### TECHNICAL FIELD

The present disclosure relates generally to fluid sample processing, and more particularly to systems for and methods of working with fluid sample processing systems.

### BACKGROUND

Fluid sample processing can involve the detection, identification and quantification of small molecules and macromolecules in fluid samples for purposes of research, clinical applications, diagnosis, treatment, and related endeavors. Such molecules and macromolecules can include, for example, proteins, peptides, antibodies, nucleic acid markers, hormones, metabolites, carbohydrates, lipids, and the like. Commercially available fluid processing systems can include various robotically controlled components for the delivery, analysis, removal, and disposal of fluids of interest. In some arrangements, such fluid processing systems can process fluids with respect to enzyme-linked immune-absorbent assay (“ELISA”) plates that can have wells configured to hold various fluids of interest.

Unfortunately, there are several drawbacks to conventional fluid processing systems. In such systems, fluids are commonly delivered to the tops of wells robotically by way of pipets and are also analyzed and removed from the wells along with other possible processing steps. This process can be time consuming, involving many steps, and fluid removal can often be inaccurate, resulting in residual fluids left behind. Furthermore, while many such fluid processing systems are robotically controlled to some extent, these systems still inconveniently require a significant amount of manual intervention and steps, with several ways of introducing error and added processing times.

Although traditional fluid sample processing systems and processing techniques have worked well in the past, improvements are always helpful. In particular, what is desired are improved fluid sample processing systems and components thereof that are more modular in order to facilitate faster, more automated, and more accurate fluid sample processing.

### SUMMARY

It is an advantage of the present disclosure to provide improved fluid sample processing systems and components thereof that are more modular in order to facilitate faster, more automated, and more accurate fluid sample processing. The disclosed systems, apparatuses, methods, and features thereof include modular fluid processing components that provide faster, more automated, and more accurate fluid removal during fluid processing. This can be accomplished at least in part due to readily installable, operable, and/or removable aspiration components associated for use with fluid sample processing systems.

In various embodiments of the present disclosure, an apparatus configured the removal of fluids within a fluid sample processing system can include an aspiration arm, a first manifold component, and a vacuum conduit. The aspiration arm can be configured to facilitate the delivery of a vacuum to one or more devices arranged into one or more rows, and the one or more devices can include one or more wells configured to hold fluid therein. The first manifold component can be coupled to the aspiration arm and can include a first set of multiple fluid transmitting extensions configured to be inserted simultaneously into the one or more wells. The vacuum conduit can be coupled to the first manifold component and can be configured to deliver vacuum to and aspirate fluids from the one or more wells.

In various detailed embodiments, the vacuum conduit can include a flexible tube coupled to a vacuum source located outside the apparatus. The aspiration arm can include one or more fluid passages located within the aspiration arm, and the one or more fluid passages can be configured to deliver vacuum from the vacuum conduit to the manifold component and transmit fluids from the manifold component into the vacuum conduit. The one or more fluid passages can be integrally formed within a flanged portion of the aspiration arm. In some arrangements, the first set of multiple fluid transmitting extensions can form a set of pipettes. The apparatus can also include a coupling arrangement configured to removably couple the first manifold component to the aspiration arm, and the coupling arrangement can be further configured to secure the first manifold component in place with respect to the aspiration arm. The coupling arrangement can be further configured to allow the first manifold component to be replaced with a second manifold component having a second set of multiple fluid transmitting extensions configured to be inserted simultaneously into the one or more wells. The second set of multiple fluid transmitting extensions can have dimensions that are different than the dimensions of the first set of multiple fluid transmitting extensions.

In various detailed embodiments, the apparatus can be configured to be moved such that the first set of multiple fluid transmitting extensions can be simultaneously removed from the one or more wells and can be inserted simultaneously into a second set of one or more wells. In some arrangements, the apparatus can be configured to be manually operated with respect to the one or more wells. In some arrangements, the apparatus can be configured to be robotically operated with respect to the one or more wells and can further include one or more coupling features. The one or more coupling features can be configured to couple the aspiration arm to a fluid handling robot of the fluid sample processing system.

In various further detailed embodiments, the apparatus can further include a first set of pipettes configured to be removably coupled to the first set of multiple fluid transmitting extensions. The first set of pipettes can be further configured to be inserted simultaneously into the one or more wells. In some embodiments, the aspiration arm can include a base component rotationally coupled to a pivot component such that the base component is configured to rotate along a longitudinal axis with respect to the pivot component. The pivot component can be coupled to the first manifold component and the base component can include one or more coupling features configured to couple the base component to a fluid handling robot of the fluid sample processing system. The pivot component can be rotationally coupled to the first manifold component and can be configured to rotate along a horizontal axis that is orthogonal to the longitudinal axis. In some arrangements, the first manifold component can include a pipette tip component, a middle component, and a base component. The base component can be coupled to the pivot component of the aspiration arm. In such arrangements, one or more fluid passages can be located within each of the pipette tip component, middle component, and base component. The one or more fluid passages can be configured to deliver vacuum from the vacuum conduit to external openings at tips of the pipette tip component and transmit fluids from the external openings into the vacuum conduit.

In further embodiments of the present disclosure, various methods of processing fluid samples are provided. Pertinent method steps can include providing one or more devices, placing a fluid, and aspirating the fluid. The one or more devices can be arranged into one or more rows and can include one or more wells configured to hold fluid therein. The fluid can be placed into the tops of the one or more wells, and the content in the fluid can be analyzed while the fluid is within the one or more wells. The fluid can be aspirated from the tops of the one or more wells using an aspiration apparatus. The aspiration apparatus can include an aspiration arm, a manifold component coupled to the aspiration arm, and a vacuum conduit configured to deliver a vacuum to the aspiration apparatus and transmit the fluid from the aspiration apparatus. The manifold component can include a first set of multiple fluid transmitting extensions configured to be inserted simultaneously into the one or more wells. The steps of placing and aspirating can be automatically performed by one or more robotic systems. One or more additional process steps can include analyzing content in the fluid and/or collecting the aspirated fluid into a waste disposal unit.

Other apparatuses, methods, features, and advantages of the disclosure will be or will become apparent to one with skill in the art upon examination of the following figures and detailed description. It is intended that all such additional apparatuses, methods, features and advantages be included within this description, be within the scope of the disclosure, and be protected by the accompanying claims.

### BRIEF DESCRIPTION OF THE DRAWINGS

The included drawings are for illustrative purposes and serve only to provide examples of possible structures and arrangements for the disclosed systems, apparatuses, features, and methods relating to fluid removal with respect to fluid sample processing systems and related system components. These drawings in no way limit any changes in form and detail that may be made to the disclosure by one skilled in the art without departing from the spirit and scope of the disclosure.

FIG. 1A illustrates in schematic view various components of an example fluid sample processing system according to one embodiment of the present disclosure.

FIG. 1B illustrates in schematic view various further components of an example fluid sample processing system according to one embodiment of the present disclosure.

FIG. 2A illustrates in top perspective view an example ELISA plate for use with a fluid sample processing system.

FIG. 2B illustrates in top perspective view an example alternative ELISA plate for use with a fluid sample processing system.

FIGS. 3A and 3B illustrate diagrams showing delivery of consumables into sample wells according to one embodiment of the present disclosure.

FIGS. 3C, 3D and 3E illustrate examples of four assay chips in a caddy according to one embodiment of the present disclosure.

FIG. 4 illustrates in front perspective view an example aspiration arm configured for fluid removal from an associated fluid sample processing system according to one embodiment of the present disclosure.

FIG. 5A illustrates in bottom perspective view an example aspiration arm coupled to a manifold component according to one embodiment of the present disclosure.

FIG. 5B illustrates in side perspective view the aspiration arm and manifold component of FIG. 5A according to one embodiment of the present disclosure.

FIG. 5C illustrates in obverse side perspective view the aspiration arm and manifold component of FIG. 5A according to one embodiment of the present disclosure.

FIG. 6A illustrates in front perspective view the aspiration arm and manifold component of FIG. 5A according to one embodiment of the present disclosure.

FIG. 6B illustrates in side perspective view an example arrangement of an aspiration arm and manifold component with pipettes inserted into fluid wells of an ELISA plate according to one embodiment of the present disclosure.

FIG. 7A illustrates in front perspective view the example arrangement of FIG. 6B according to one embodiment of the present disclosure.

FIG. 7B illustrates in alternative perspective view the example arrangement of FIG. 6B according to one embodiment of the present disclosure.

FIG. 8A illustrates in top plan view an example alternative apparatus configured for fluid removal from an associated fluid sample processing system according to one embodiment of the present disclosure.

FIG. 8B illustrates in side perspective view the fluid removal apparatus of FIG. 8A according to one embodiment of the present disclosure.

FIG. 9A illustrates in top plan view an example fluid removal apparatus including the aspiration arm and manifold component of FIG. 8A with a vacuum conduit and set of pipette tips coupled thereto according to one embodiment of the present disclosure.

FIG. 9B illustrates in front perspective view the fluid removal apparatus of FIG. 9A with the set of pipette tips inserted into fluid wells of an ELISA plate according to one embodiment of the present disclosure.

FIG. 10 illustrates in perspective view the fluid removal apparatus of FIG. 9A according to one embodiment of the present disclosure.

FIG. 11A illustrates in perspective exploded view the fluid removal apparatus of FIG. 9A according to one embodiment of the present disclosure.

FIG. 11B illustrates in front exploded view the fluid removal apparatus of FIG. 9A according to one embodiment of the present disclosure.

FIG. 12 illustrates in front cross-section view the fluid removal apparatus of FIG. 9A according to one embodiment of the present disclosure.

FIG. 13 illustrates in perspective cross-section view the fluid removal apparatus of FIG. 9A with highlighted fluid flow paths according to one embodiment of the present disclosure.

FIG. 14 illustrates in side perspective and partial cutaway view an example external box according to one embodiment of the present disclosure.

FIG. 15A illustrates a flowchart of an example method of manually aspirating fluids within a fluid sample processing system according to one embodiment of the present disclosure.

FIG. 15B illustrates a flowchart of an example method of automatically aspirating fluids within a fluid sample processing system according to one embodiment of the present disclosure.

FIG. 16 illustrates a flowchart of an example method of processing fluid samples according to one embodiment of the present disclosure.

### DETAILED DESCRIPTION

Exemplary applications of apparatuses, systems, and methods according to the present disclosure are described in this section. These examples are being provided solely to add context and aid in the understanding of the disclosure. It will thus be apparent to one skilled in the art that the present disclosure may be practiced without some or all of these specific details provided herein. In some instances, well known process steps have not been described in detail in order to avoid unnecessarily obscuring the present disclosure. Other applications are possible, such that the following examples should not be taken as limiting. In the following detailed description, references are made to the accompanying drawings, which form a part of the description and in which are shown, by way of illustration, specific embodiments of the present disclosure. Although these embodiments are described in sufficient detail to enable one skilled in the art to practice the disclosure, it is understood that these examples are not limiting, such that other embodiments may be used, and changes may be made without departing from the spirit and scope of the disclosure.

The present disclosure relates in various embodiments to systems, apparatuses, features, and methods involving fluid removal from fluid sample processing systems and associated components thereof. In particular, the disclosed embodiments provide fluid removal components, apparatuses, and methods that facilitate faster and more accurate fluid removal with little to no residual fluid left behind. Such components can include, for example, vacuum sources, aspiration arms, attachments, tubing, manifolds, controllers, and other various other components and features for use therewith. Such components can also include items or features that allow for the automated removal of fluids as well as the removal of fluids through manual application of the various aspiration arms, attachments, and other components disclosed herein.

Although the various embodiments disclosed herein focus on fluid sample processing involving the detection, identification and quantification of small molecules and macromolecules for purposes of simplicity in illustration, it will be readily appreciated that the disclosed systems, apparatuses, features, and methods can similarly be used for any other kind of fluid handling system. For example, the disclosed systems, apparatuses, features, and methods can be used for other fluid handling systems that can take advantage of the innovative modular and improved aspiration aspects disclosed herein to realize automated, faster, and more accurate fluid handling.

The disclosed fluid sample processing system can generally include an automated liquid handling robot and various fluid removal components. The automated liquid handling robot can be a custom-designed robot having microliter pipetting capabilities, and can be programmed to deliver, add, aspirate, and/or otherwise remove liquids from one or more sample wells at defined time intervals or in pre-determined conditions. The liquid handling robot can additionally be configured to automatically carry out all necessary sample preparation steps, such as reagent mixing and sample dilution, among other possible actions.

In various arrangements, the automated liquid handling robot can be used with an apparatus that can include a custom designed and manufactured aspiration arm. The aspiration arm can include or be coupled to an aspiration manifold configured to be connected to a vacuum line. The size of the manifold may be varied to adjust for attachment of macrotips or microtips, such that the robot may deliver and/or aspirate reagents, buffers, or the like into one or more sample wells as needed, with millimeter or sub-millimeter accuracy. In some arrangements, the aspiration arm, manifold, and other associated components can be manually used to aspirate or otherwise remove fluids without using the automated liquid handling robot for aspiration purposes. Other applications of the disclosed apparatuses configured for fluid removal are also possible.

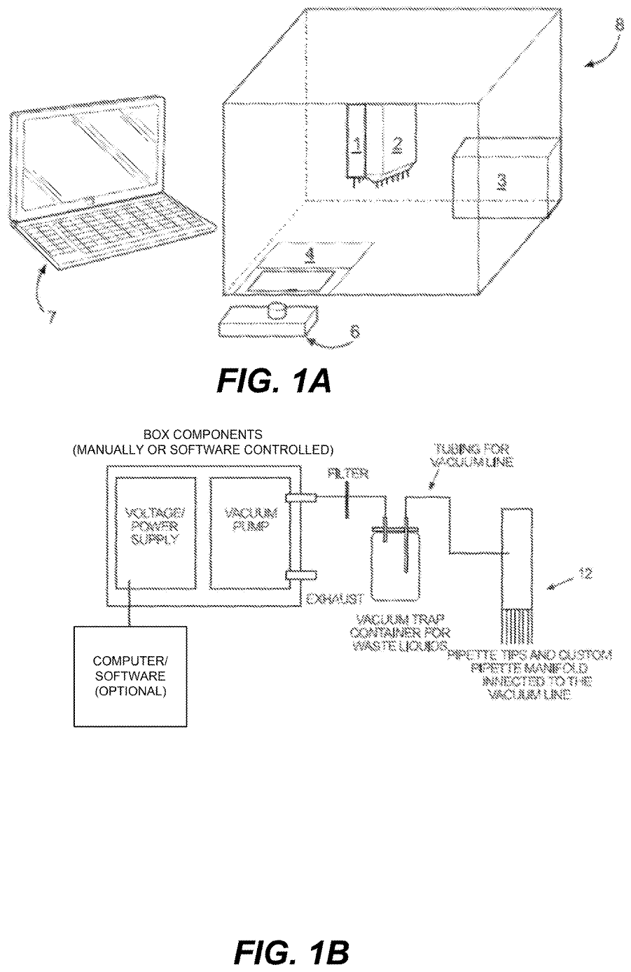

Referring first to FIGS. 1A and 1B, various components of an example fluid sample processing system are shown. Such a system can be, for example, an automated analyte detection and quantification system with direct sampling capabilities. A fluid (e.g., liquid) handling robot of the system can include a frame 8 for holding robotic components. The robot can include a multichannel fluid-handling pipette 1, a vacuum arm with removable pipette tips 2, integrated components 3 (e.g., power supply and vacuum pump), an open position for connector assembly 4, an imaging unit 6 (which may be integrated with the robot, or and external imaging unit), and an associated computer 7, among other possible components.

With regard to FIG. 1B, a sub-unit can occupy one position within a “deck” of the robot layout, whereas reagents, pipette tips, or other consumables can occupy other areas within the robot layout. A box and internal components can be controlled via a computer and software. Communications can be in a wired or wireless format. A vacuum arm or part 12 can be designed to fit to a fluid handling control arm. The arm or part can move in 2 or 3 dimensions (e.g., in an x, y, z space) to remove fluid from wells. The vacuum arm or part can have multiple tips, such as 8, 12, 16, or hundreds of tips, although other amounts of tips are also possible. More or fewer tips can be used, and tips can be arranged into more than one row in some arrangements.

A pipettor of the liquid handling robot can travel back and forth between the sub-unit and other locations on the robot deck and can carry out pre-programmed functions. Liquids or fluids can be delivered to one or more wells (or micro-wells) within one or more related system devices, such as assay devices, for example. Other non-assay devices are also possible. All functions can be carried out via the laptop computer shown on the far left in the robot layout.

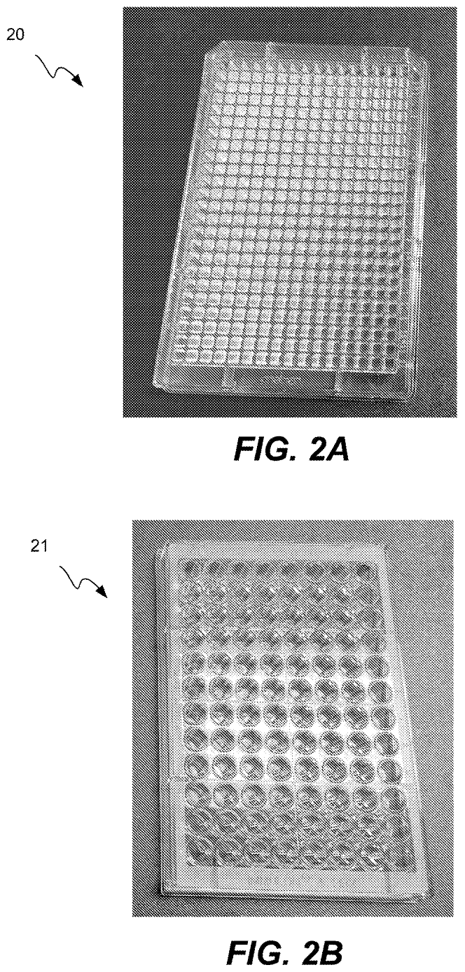

Referring next to FIGS. 2A and 2B, different example ELISA plates for use with a fluid sample processing system are shown in top perspective view. Plate 20 can be, for example, a 384 well standard ELISA plate. Plate 21 can be, for example, a 96 well standard ELISA plate. Either of plates 20 or 21 can be used with the various systems, apparatuses, components, and other embodiments disclosed herein. Other sizes, well amounts, and types of plates can be used as well. Such other plates can include, for example, 12 well, 24 well, 1536 well ELISA plates, as well as other off the shelf and custom made ELISA plates and kits. Other plate-based assays that may be used with the various systems, apparatuses, components, and embodiments disclosed herein can include magnetic bead assays and polystryrene bead assays, for example. Cell-culture applications requiring media aspiration and cell-based assay washing and aspiration can also be used with various disclosed embodiments. Other types of well-based and fluid holding devices may also be used, and such other types of devices need not be assay-based devices in all embodiments, as will be readily appreciated.

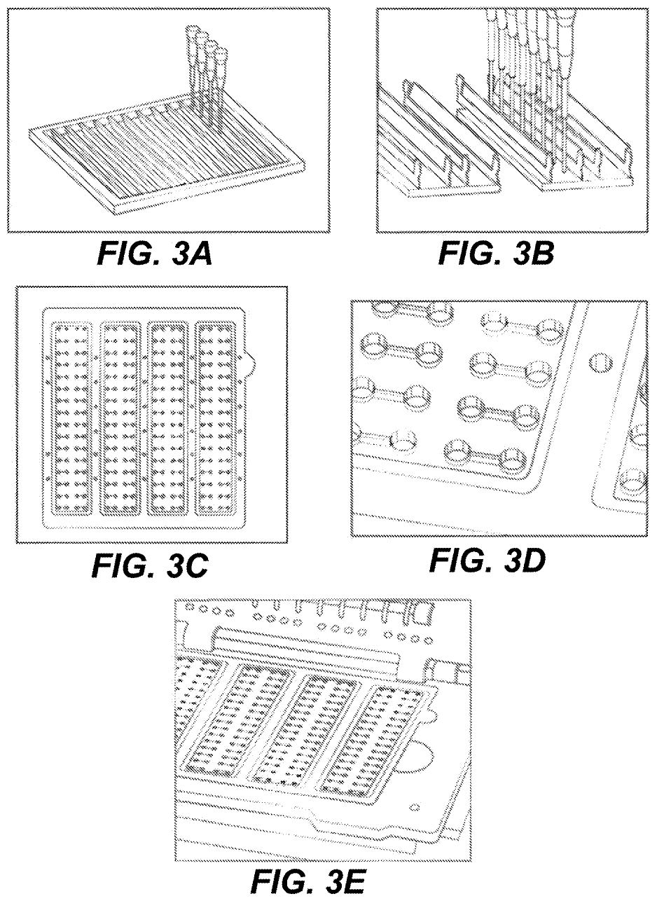

FIGS. 3A and 3B show delivery of consumables into sample wells of a chip caddy by individual pipette tips, which can be guided and directed by a liquid handling robot. Electrode rails, which run diagonally in the image, do not interfere with the liquid delivery to the wells. FIGS. 3C, 3D, and 3E show four assay chips in a frame that can accommodate up to 128 samples at one time. The example chip caddy of FIG. 3C can hold four assay chips. The chip caddy can be compatible with most biological buffers and chemicals, so chips can be installed to the caddy and stored in wet conditions. Each well in the customized assay chip can have a diameter of approximately 2 mm and can hold about 2.5 μl of volume. The assay chips can be seated within the assay sub-unit. For example, in a 128 sample chip caddy, there would be a total of 256 wells. The 256 wells can be 2 mm sized. A corresponding number of electrodes can be used to apply voltage into the wells. In one example, considering the wells are 2 mm, electrodes can be 0.5 mm and pipette tips can be 0.07 mm. While the various components and items of FIGS. 3A through 3E depict particular types of assay devices having wells configured for containing fluid, it will be readily appreciated that the disclosed systems, apparatuses, components and features can also be used with any other suitable form of devices and other components having one or more wells configured for containing fluid. Again, not all such devices need to be assay-based, as the disclosed fluid removal system, apparatuses, features, and methods can be used for any type of system or device having fluid to be removed from one or more wells.

Further details of an automated fluid sample processing system can be found in, for example, commonly owned PCT Patent Application No. PCT/US2021/14800 filed Jan. 22, 2021 and titled “AUTOMATED ANALYTE MEASUREMENT SYSTEMS AND KITS FOR USE THEREWITH,” which is incorporated by reference in its entirety herein. Still further details of automated fluid sample processing systems can be found in, for example, U.S. Pat. No. 10,634,673 to Araz et al., titled “ELECTROPHORETIC BAR CODE ASSAY DEVICES AND METHODS FOR MAKING AND USING THE SAME,” which is also incorporated by reference in its entirety herein.

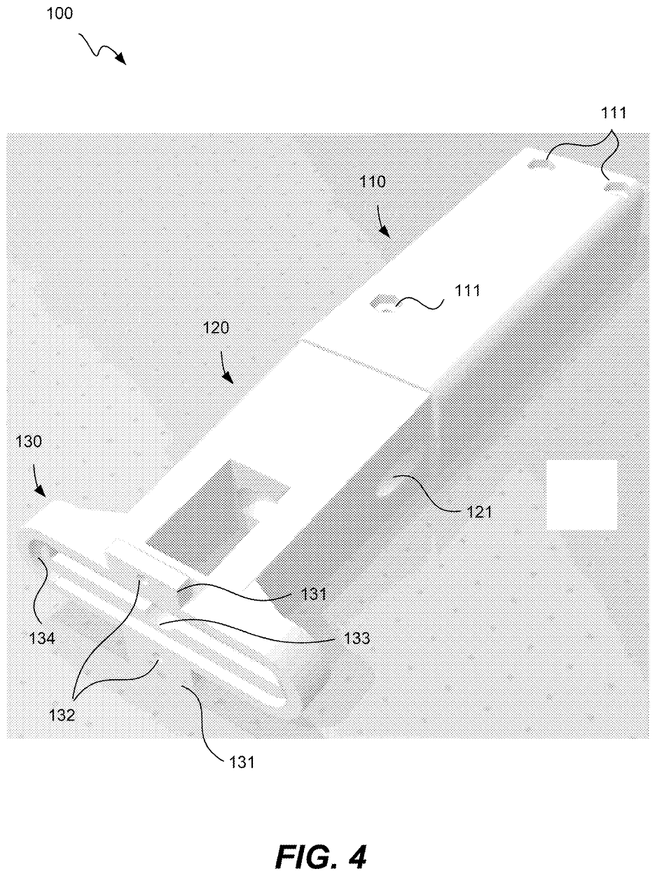

Transitioning now to FIG. 4, an example aspiration arm configured for fluid removal from an associated fluid sample processing system is illustrated in front perspective view. In various embodiments, aspiration arm 100 can be configured to facilitate the removal of fluid from an associated fluid sample processing system. Such fluid can be for example, various liquids that need to be removed from the wells of one or more ELISA plates or other fluid holding components within a fluid sample processing system.

Aspiration arm 100 can be formed of one or more solid materials, such as a lightweight polymer three-dimensionally printed material, for example. Alternatively, other plastic, metal, and/or other suitable materials may also be used. In some arrangements, aspiration arm 100 can include an upper portion 110 and a lower portion 120 that can be coupled together, while in other arrangements the entire aspiration arm can be integrally formed. Flanged portion 130 can be located along the bottom of lower portion 120 of aspiration arm 100, and this flanged portion can be configured to facilitate the flow of fluids therethrough.

In various embodiments, one or more surface mounting mechanisms can be configured to couple aspiration arm 100 to a gantry of a liquid handling robot, such as that which is shown above in FIG. 1, and the aspiration arm can be custom-designed to fit the liquid handling robot. For example, one or more openings 111 along upper portion 110 of aspiration arm 100 can be configured to facilitate coupling to a fluid handling robot, such as by way of screws, bolts, or other coupling components. In some arrangements, openings 111 and the associated coupling components can be designed to match features provided on existing commercially available fluid handling robots, such as on a gantry arm of a fluid handling robot.

In various embodiments, flanged portion 130 can include one or more tabs 131 having one or more openings 132 configured to facilitate attachment of a removable manifold component, as detailed below. Slot 133 and/or one or more other features can be formed within flanged portion 130 to further facilitate attachment of such a removable manifold component. Flanged portion 130 can also include one or more fluid passages 134 formed therewithin to facilitate the flow of fluid through the flanged portion. One or more openings 121 located along lower portion 120 can accommodate a vacuum tube (not shown) or other conduit that can be arranged to couple fluid passages 134 with an outside vacuum source.

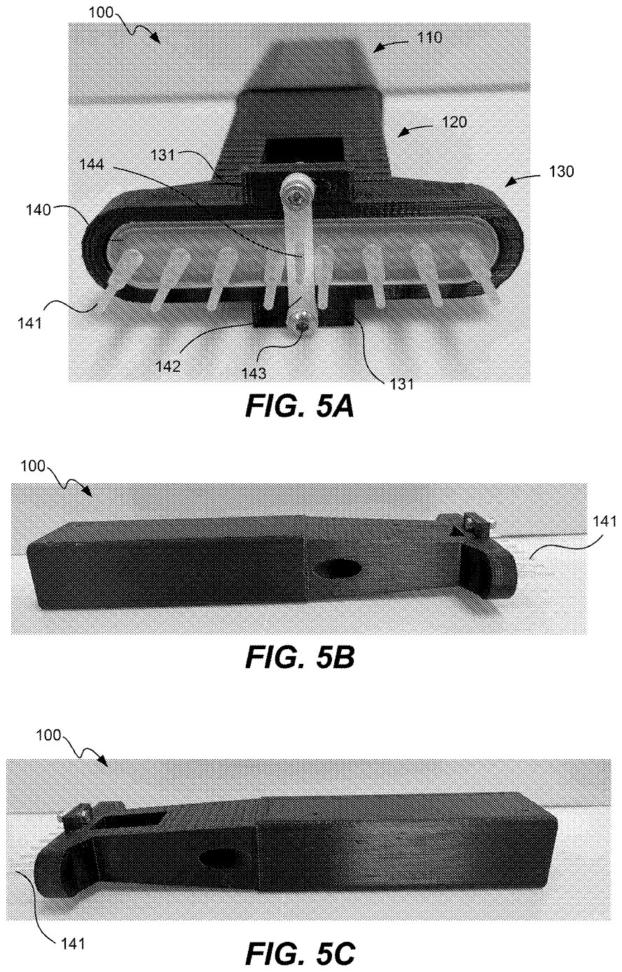

Turning next to FIGS. 5A-5C, an example aspiration arm coupled to a manifold component is shown in bottom perspective, side perspective, and obverse side perspective views respectively. Again, aspiration arm 100 can include an upper portion 110, a lower portion 120, and a flanged portion 130. Manifold component 140 can be coupled to aspiration arm 100 along a bottom surface of flanged portion 130 such that the fluid passages within the flanged portion are at least partially covered by the manifold component. Multiple fluid transmitting extensions 141 can extend from manifold component 140, and these extensions can be configured to be inserted simultaneously into multiple wells of an assay device or other fluid holding type of device. Vacuum can be delivered through these components into the wells such that fluid can then be aspirated from the wells through fluid transmitting extensions 141 and into the fluid passages within flanged portion 130 of aspiration arm 100. In some embodiments, aspiration arm 100 can be integrally formed with manifold component 140.

In some arrangements, fluid transmitting extensions 141 can be integrally formed with manifold component 140, which can also be considered an aspiration manifold. As such, manifold component 140 can be a fixed multiplex tip attachment, pipettor, or aspiration manifold that couples to aspiration arm to form part of an overall fluid removal device or system. While eight fluid transmitting extensions 141 are shown, it will readily be appreciated that more or fewer extensions may be used for a given manifold. In some embodiments, one or more removable and/or disposable pipette tips (not shown) may be placed atop the fluid transmitting extensions 141 during use of aspiration arm 100.

Cross piece 142 can be used to hold manifold component 140 in place against a bottom surface of flanged portion 130. This can be facilitated by way of one or more coupling components 143, such as screws that can be inserted through holes of cross piece 142 and into holes within integrally formed tabs 131 of flanged portion 130, as noted above. Protrusion 144 can extend outward from manifold component 140 and through an opening in cross piece 142 to limit or prevent lateral movement of the manifold component as it is coupled to flange portion 130 of aspiration arm 100. Protrusion 144 can be integrally formed with manifold component 140. In some arrangements, manifold component 140 can be removed from aspiration arm 100 and replaced with another similar manifold component that may have the same or different dimensions than the replaced manifold component.

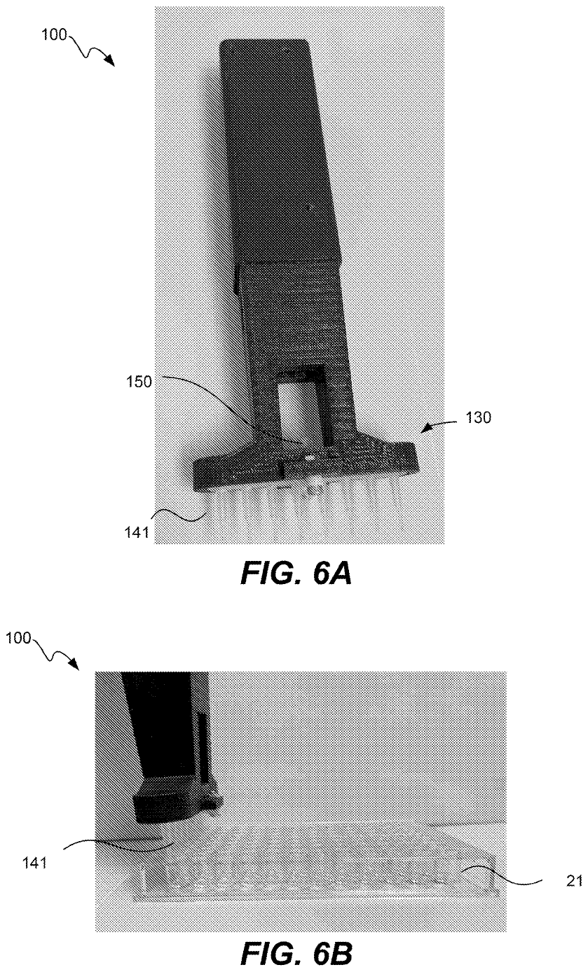

Continuing with FIG. 6A, the aspiration arm and manifold component of FIG. 5A is illustrated in front perspective view. Again, fluid transmitting extensions 141 can serve as pipettes that directly aspirate fluid from one or more wells of an assay device or other similar fluid holding component. Alternatively, or in addition, removable and replaceable pipettes can be placed atop some or all of fluid transmitting extensions 141. Vacuum conduit 150 can be coupled to manifold component 140, which can be by way of the fluid passages within flanged portion 130. For example, vacuum conduit 150 can be a port or connector for a vacuum tube or other vacuum transmission line to a vacuum source, and this port can couple to and extend directly from a top central region of flanged portion 130, as shown. As such, vacuum conduit 150 can be configured to deliver vacuum to and aspirate fluids from multiple wells by way of the fluid passages within flanged portion 130 and fluid transmitting extensions 141. In some arrangements, the vacuum tube itself can also be considered as part of an overall vacuum conduit.

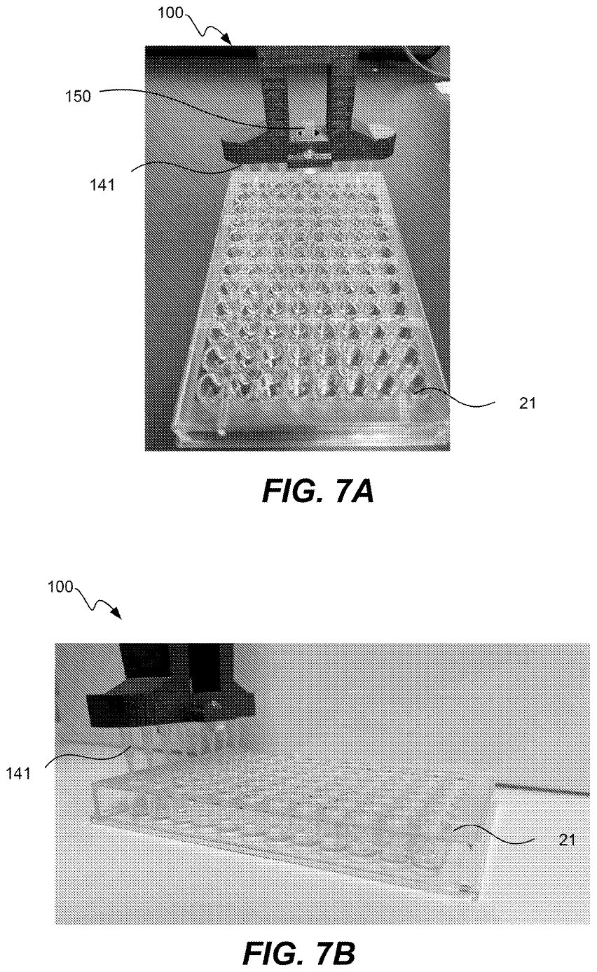

FIG. 6B illustrates in side perspective view an example arrangement of an aspiration arm and manifold component with pipettes inserted into fluid wells of an ELISA plate. FIGS. 7A and 7B similarly illustrate the arrangement of FIG. 6B in front perspective and alternate perspective views respectively. As shown, aspiration arm 100 can have multiple pipettes or other fluid transmitting extensions 141 extending therefrom and inserted into wells of plate 21. Vacuum conduit 150 can be coupled to a flanged region of aspiration arm 100 and can be configured to accommodate a vacuum tube or other suitable vacuum delivery component. Again, fluid can be aspirated from the wells of plate 21 by delivering a vacuum through vacuum conduit 150, through internal fluid passages within the flanged region of aspiration arm 100, through pipettes or other fluid transmitting extensions 141, and into the wells, such that the fluid can travel a reverse path through these components and through a flexible vacuum tube or other suitable vacuum delivery component (not shown) coupled to the vacuum conduit.

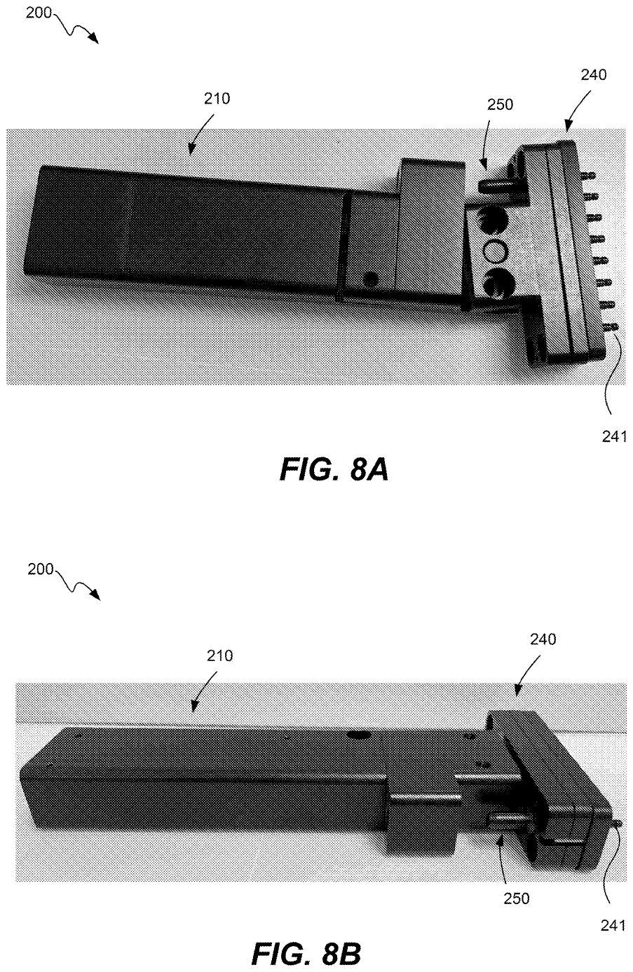

While aspiration arm 100, manifold component 140, vacuum conduit 150, and other associated components shown and described above with respect to FIGS. 4 through 7B provide one specific embodiment of an apparatus configured for the removal of fluids within a fluid sample processing system, it will be readily appreciated that other specific embodiments of such apparatuses are also possible. Moving next to FIGS. 8A and 8B an example alternative apparatus configured for fluid removal from an associated fluid sample processing system is shown in top plan and side perspective views respectively. Fluid removal apparatus 200 can include an aspiration arm 210, a manifold component 240 coupled to the aspiration arm, and a vacuum conduit 250 coupled to the manifold component.

Similar to the foregoing fluid removal apparatus shown and described above with respect to FIGS. 4 through 7B, manifold component 240 of fluid removal apparatus 200 can include a set of multiple fluid transmitting extensions 241 protruding therefrom. Also similar to the foregoing embodiment, aspiration arm 210 can be configured to facilitate the delivery of a vacuum to one or more devices arranged into one or more rows, the one or more devices including one or more wells configured to hold fluid therein, multiple fluid transmitting extensions 241 can be configured to be inserted simultaneously into one or more wells, and vacuum conduit 250 can be configured to deliver vacuum to and aspirate fluids from the one or more wells.

Unlike the foregoing embodiment disclosed above, fluid removal apparatus 200 can have various additional and alternative components and features, some or all of which can be formed of different materials. For example, aspiration arm 210, manifold component 240, fluid transmitting extensions 241, and vacuum conduit 250 can all be formed from machined metal. Of course, other suitable materials may alternatively be used. Other components and features of fluid removal apparatus 200 can allow for relative movement between aspiration arm 210 and manifold component 240 in two or three degrees of freedom to allow for better alignment with one or both of an associated fluid handling robot and an assay device or other type of device having one or more fluid wells for better aspiration of fluid from the one or more wells, as set forth in greater detail below.

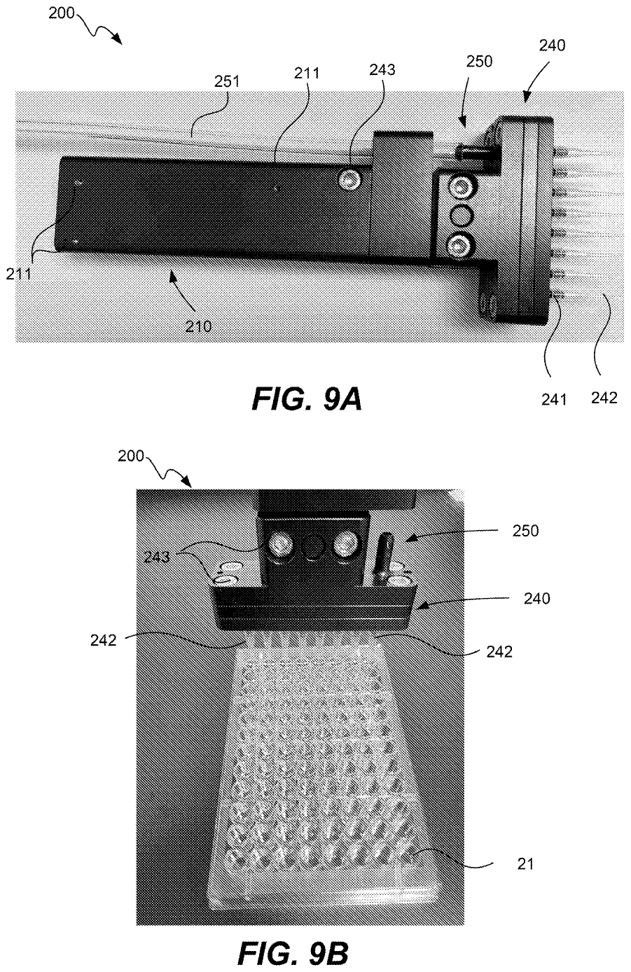

Continuing with FIG. 9A, an example fluid removal apparatus including the aspiration arm and manifold component of FIG. 8A with a vacuum conduit and set of pipette tips coupled thereto is illustrated in top plan view. Again, fluid removal apparatus 200 can include aspiration arm 210, manifold component 240 with fluid transmitting extensions 241, and vacuum conduit 250. Openings 211 or other coupling features on aspiration arm 210 can be configured to facilitate coupling to a fluid handling robot, such as by way of screws, bolts, or other coupling components. A set of removable pipette tips 242 can be fitted atop fluid transmitting extensions 241 to facilitate reaching the bottoms of associated wells to aspirate all fluids therefrom. Vacuum tube 251 can be coupled to vacuum conduit 250 to facilitate delivery of a vacuum from a remotely located vacuum source to the removable pipette tips 242 and aspiration of fluids back through the vacuum tube.

FIG. 9B depicts the fluid removal apparatus of FIG. 9A in front perspective view with the set of pipette tips inserted into fluid wells of an ELISA plate. Again, manifold component 240 of fluid removal apparatus can have a set of removable pipette tips 242 extending therefrom, and these pipette tips can extend into fluid wells of plate 21. Although eight pipette tips 242 are shown in the illustrated set of pipette tips, it will be readily appreciated that more or fewer pipette tips may be used. In some embodiments, an ejector mechanism (not shown) can be used to eject used pipette tips 242 from their respective fluid transmitting extensions from manifold component 240. New pipette tips can then be placed onto the fluid transmitting extensions, and this can be done manually or automatically through the use of an associated liquid handling robot and associated location mapping and software programming. One or more locking components 243, such as screws, bolts, or setscrews, for example, can be configured to lock various components of manifold component 240 in place with respect to each other and/or with respect to the aspiration arm, as detailed below.

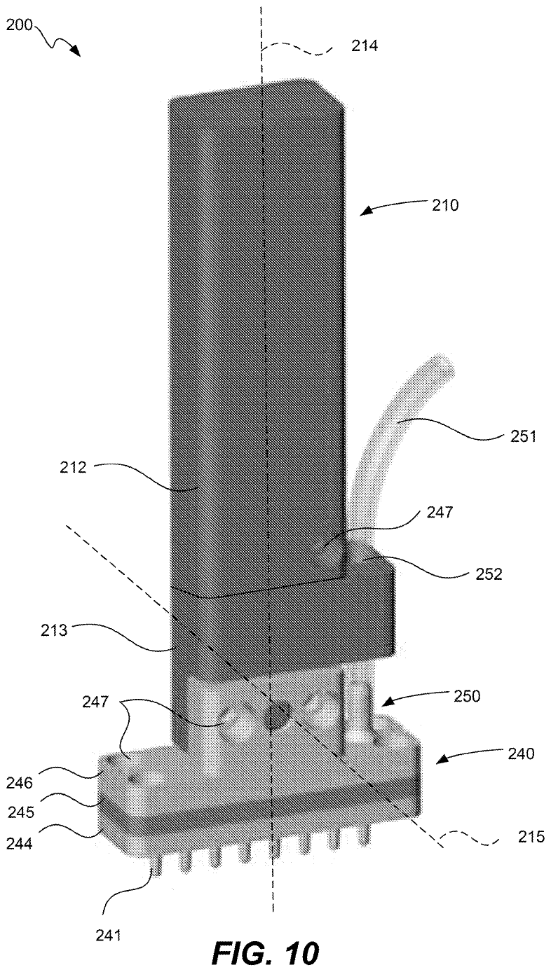

Turning next to FIG. 10, the fluid removal apparatus of FIG. 9A is illustrated in front perspective view. Various components of fluid removal apparatus 200 can facilitate an accurate placement and alignment with respect to a robotic handling unit and/or fluid wells within one or more devices. For example, aspiration arm 210 can include an arm base component 212 rotationally coupled to an arm pivot component 213 such that the arm base component is configured to rotate along a longitudinal axis 214 with respect to the arm pivot component. Arm pivot component 213 can be rotationally coupled to manifold component 240 such that the arm pivot component is configured to rotate along a horizontal axis 215 that is orthogonal to the longitudinal axis 214. Manifold component 240 can include pipette tip component 244, middle component 245, and manifold base component 246, all of which can be layered atop each other. Manifold base component 246 can be the portion of manifold component 240 that is coupled to arm pivot component 213 of aspiration arm 210. Various openings 247 within arm base component 212, arm pivot component 213, pipette tip component 244, middle component 245, and manifold base component 246 can facilitate the insertion of locking components as disclosed above to lock these various components in place with respect to each other once appropriate relative orientations and alignments for these various components are set.

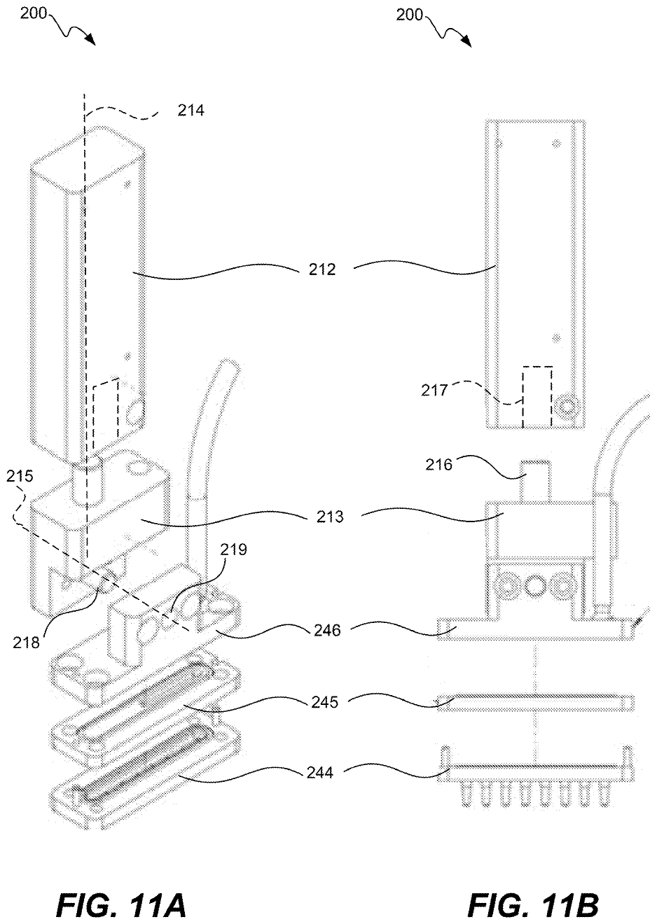

These relative arrangements and degrees of rotational freedom of these various components can also be seen with respect to FIGS. 11A and 11B, which illustrate the fluid removal apparatus in perspective exploded view and front exploded view respectively. Vertical protrusion 216 from arm pivot component 213 can extend into vertical opening 217 within arm base component 212 to facilitate rotation of the arm base component with respect to the arm pivot component about longitudinal axis 214. Horizontal protrusion 218 from arm pivot component 212 can extend into horizontal opening 219 within manifold base component 246 to facilitate rotation of the arm pivot component with respect to the manifold base component about horizontal axis 215.

It will be readily appreciated that component rotations about longitudinal axis 214 and horizontal axis 215 provide two degrees of freedom for alignment and operation of overall fluid removal apparatus 200. It is specifically contemplated that additional degrees of freedom for alignment and operation may also be included for even more accuracy and ease of operation for any given fluid removal apparatus. For example, additional component(s) and rotational ability can be incorporated with respect to a third axis that is orthogonal with respect to both of axes 214 and 215, such that the overall manifold component 240 can pivot forward and backward with respect to aspiration arm 210 to provide a third degree of freedom. Other axes and relative rotation facilitating components and arrangements are also possible.

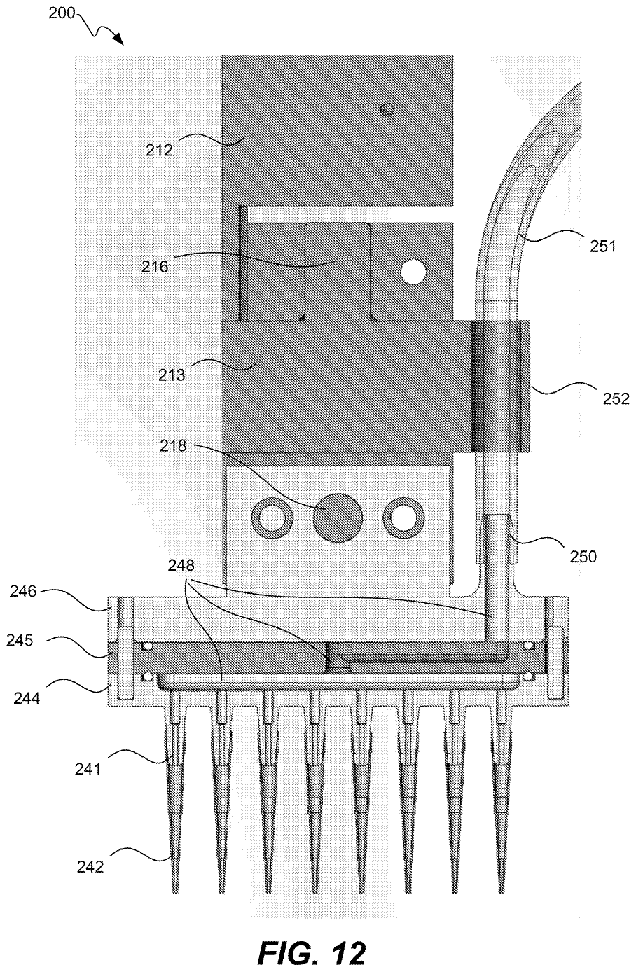

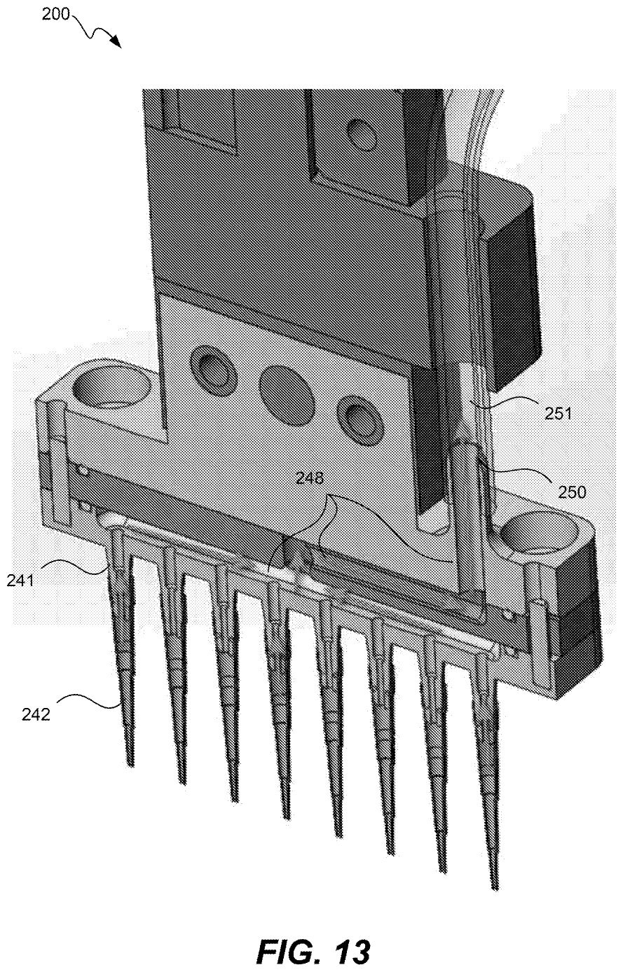

FIGS. 12 and 13 illustrates the fluid removal apparatus of FIG. 9A in front cross-section and perspective cross-section views respectively. Again, fluid removal apparatus 200 can include arm base component 212, arm pivot component 213, and a manifold component that can include removable pipette tips 242 fitted atop fluid transmitting extensions 241, pipette tip component 244, middle component 245, and manifold base component 246. Vertical protrusion 216 from arm pivot component 213 can facilitate the rotation of arm base component 212 with respect to the arm pivot component. Horizontal protrusion 218 from arm pivot component 213 can facilitate the rotation of the arm pivot component with respect to manifold base component 246. One or more fluid passages 248 located within each of the pipette tip component 244, middle component 245, and manifold base component 246 can be configured to deliver vacuum from vacuum conduit 250 to external openings at tips of the pipette tip component and transmit fluids from the external openings into a vacuum tube 251 coupled to the vacuum conduit. A hollowed extension 252 from arm pivot component can house and provide stability to a portion of vacuum tube 251 as this vacuum tube extends away from vacuum conduit 250.

Various arrows shown in FIG. 13 depict highlighted fluid paths as fluid is aspirated from multiple wells (not shown) into openings at the tips of removable pipette tips 242. As shown, the aspirated fluid travels through removable pipette tips 242, then fluid transmitting extensions 241, then through various fluid passages 248 internal to various portion of manifold component 240, then through vacuum conduit 250, and finally through vacuum tube 251 toward a remotely located vacuum source.

As noted above, the aspiration arms, manifolds, and other associated components of the various disclosed fluid removal apparatuses can be manually operated to aspirate or otherwise remove fluids, or these apparatuses and components can be operated automatically, such as by using an automated liquid handling robot or another type of robot. Attachment or coupling to a secondary gantry of a commercially available liquid handling robot is possible, as explained above. In other arrangements, other types of robots can involve independently operated gripper robots that can be configured to grip the aspirator arm of a fluid removal apparatus to move and manipulate the overall apparatus. In some embodiments, a shortened aspiration arm or no aspiration arm at all may be used with a given gripper robot and fluid removal apparatus arrangement. For example, a separately operated gripper arm of the robot can be configured to grip and move only manifold component 240 of fluid removal apparatus 200 above, such that all portions of aspiration arm 210 are not necessary in such an arrangement. In another example, the manifold component 240 of liquid removal apparatus could be picked up by the existing pipettors via, in one embodiment a tapered press fit interface, in one embodiment a spring mechanism actuated by the pipette arm, or other such interface mechanisms, and moved within the robot deck and dropped when done in a similar fashion to pipette tips. Other applications of the disclosed apparatuses configured for fluid removal are also possible.

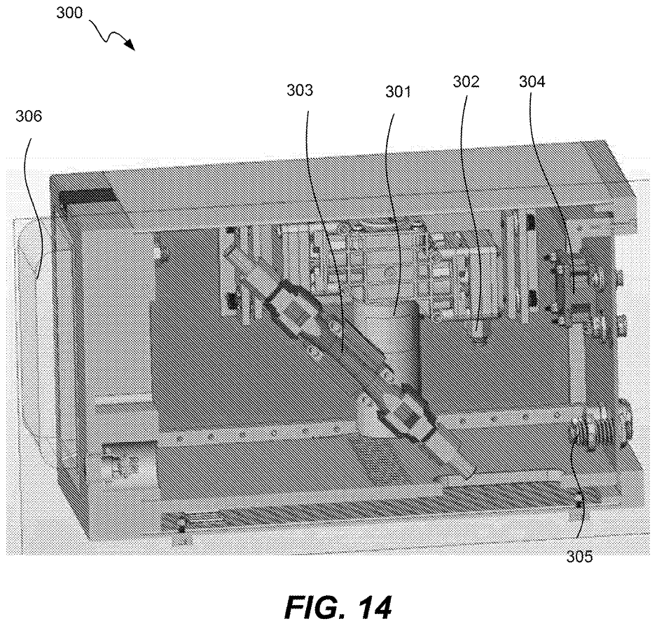

Turning next to FIG. 14 an example external box is illustrated in side perspective and partial cutaway view. External box 300, which can also be called a “vacuum box” or “outside box,” can be considered as a waste disposal module in some arrangements. External box 300 can be modular with respect to an overall fluid sample processing system such that it can be readily and easily installed with respect to the overall system. External box 300 generally serves to provide a vacuum source to the system and to collect waste fluids from the system.

External box 300 can contain various components that may be unsuitable for being within the robot or other overall system components. Such external box components can include, for example, a pump 301 configured to generate a vacuum, one or more pump inlets and outlets 302, a flow sensor 303 configured to detect flow rates, a fan 304 configured to cool external box 300, and one or more port connectors 305 configured to couple the pump (i.e. vacuum source) to an aspiration apparatus or other apparatus configured for the removal of fluids within a fluid processing system, among other components.

External box 300 (i.e., waste disposal module) can also include a removable waste disposal unit 306 coupled to the vacuum pump 301 within the external box and to the system via port connectors 305. Removable waste disposal unit 306 can be configured to hold waste materials from the system, such as various fluids aspirated from the aspiration apparatus. As will be readily appreciated, vacuum generated by pump 301 can provide the vacuum to the system to aspirate and remove waste materials from the system and then deposit the waste materials into removable waste disposal unit 306, which can be removed from external box 300 as needed to empty the waste contents therefrom and then be reinstalled.

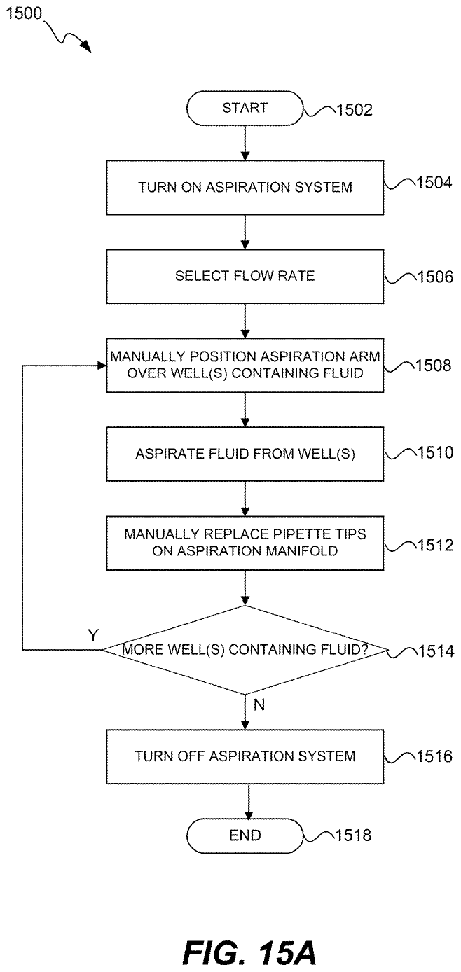

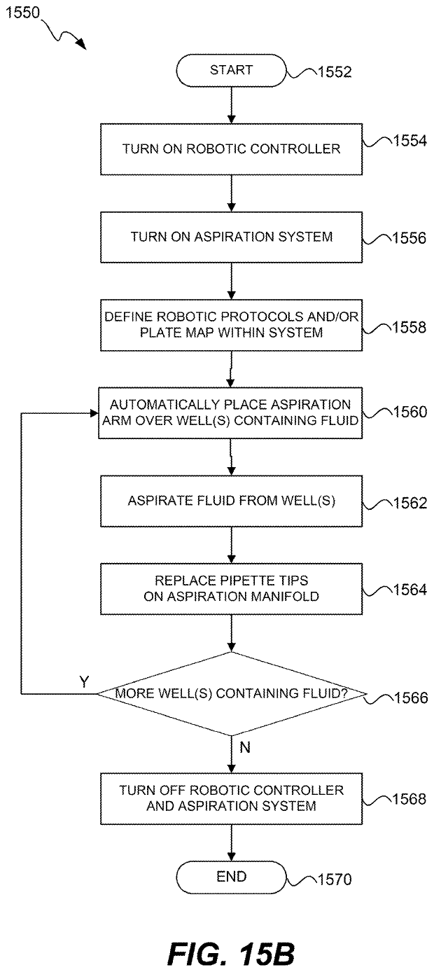

FIG. 15A illustrates a flowchart of an example method of manually aspirating fluids within a fluid sample processing system according to one embodiment of the present disclosure. In various embodiments, method 1500 can be applied using the various systems, modules, apparatuses, and features provided above. After a start step 1502, a first process step 1504 can involve turning on an aspiration system. Such an aspiration system can include an apparatus having an aspiration arm, a manifold component, and a vacuum conduit, as disclosed above. The aspiration system can also include tubing for a vacuum line, a vacuum source, a controller or other processor, and various other components such as those disclosed in outside box 300 above.

At a following process step 1506, a flow rate can be selected. This can involve providing an input to the aspiration system, such as through an interface or other input component associated with a system controller. A subsequent process step 1508 can involve manually positioning an aspiration arm over wells containing a fluid. The aspiration arm can be part of an apparatus configured for the removal of fluids and the wells can be on an assay device or other type of device within a fluid sample processing system.

The next process step 1510 can involve aspirating the fluid from the wells. This can take place by applying a vacuum from a vacuum source to the aspiration arm and into the wells, such as by way of a set of pipettes and/or pipette tips. The applied vacuum can then result in the aspiration or removal of the fluid from the wells through the pipettes (or pipette tips), aspiration arm, and vacuum tubing to the vacuum source.

At a following process step 1512, pipette tips on an aspiration manifold can be removed. The aspiration manifold can be coupled to the aspiration arm, as noted above, and the removed pipette tips can be replaced with new or cleaned pipette tips in some arrangements. In various arrangements, removal and/or replacement of pipette tips can be performed manually.

A decision step 1514 can then involve an inquiry as to whether any more wells contain fluid that needs to be aspirated. If so, then steps 1508 through 1514 can be repeated. If not, then the method can continue to step 1516. In the event that no more wells contain fluid to be aspirated, then the aspiration system can be turned off at process step 1516. The method then ends at end step 1518.

FIG. 15B illustrates a flowchart of an example method of automatically aspirating fluids within a fluid sample processing system according to one embodiment of the present disclosure. In various embodiments, method 1550 can be applied using the various systems, modules, apparatuses, and features provided above. After a start step 1552, a first process step 1554 can involve turning on a robotic controller. Such a robotic controller can control, for example, an automated robot within a fluid sample processing system.

A following process step 1556 can involve turning on an aspiration system. Again, such an aspiration system can include an apparatus having an aspiration arm, a manifold component, and a vacuum conduit, as disclosed above. The aspiration system can also include tubing for a vacuum line, a vacuum source, a controller or other processor, and various other components such as those disclosed in outside box 300 above.

At the next process step 1558, one or more robotic protocols and/or plate maps can be defined within the overall system. This can involve providing exact paths for the robot to travel with pipette arrays to deliver fluids and to aspirate or remove fluids from assay devices or other types of devices having wells configured to hold fluid.

At a subsequent process step 1560, an aspiration arm can be automatically placed over wells containing fluid. This can be automatically performed by a fluid handling robot within the fluid sample processing system and can be facilitated where the aspiration arm is coupled to a robotic component. The fluid in the wells can be placed by one or more other components of or associated with the fluid handling robot in some arrangements.

The next process step 1562 can involve aspirating the fluid from the wells. Again, this can take place by applying a vacuum from a vacuum source to the aspiration arm and into the wells, such as by way of a set of pipettes and/or pipette tips. The applied vacuum can then result in the aspiration or removal of the fluid from the wells through the pipettes (and/or pipette tips), aspiration arm, and vacuum tubing to the vacuum source.

At a following process step 1564, pipette tips on an aspiration manifold can be removed. The aspiration manifold can be coupled to the aspiration arm, as noted above, and the removed pipette tips can be replaced with new or cleaned pipette tips in some arrangements. In some arrangements, this removal and/or replacement of pipette tips can be automatically performed, such as by way of the fluid handling robot.

A decision step 1566 can then involve an inquiry as to whether any more wells contain fluid that needs to be aspirated. If so, then steps 1560 through 1566 can be repeated. If not, then the method can continue to step 1568. In the event that no more wells contain fluid to be aspirated, then the robotic controller and/or aspiration system can be turned off at process step 1568. The method then ends at end step 1570.

It will be readily appreciated that various software applications and aspects can be provided to facilitate some or all of the various automated processes noted herein. For example, software command scheduling can include software to allow programming of required device steps and durations in a graphical user interface for a system operator, as well as various communications via one or more APIs to send commands for associated liquid handler steps to be executed at appropriate times. Software command scheduling can also include commands to one or more separate microcontrollers to control various aspects of the aspirator arm and associated components (e.g., vacuum pump) to execute aspiration steps at desired times. Alternatively, the liquid handling system software can act as a master system controller sending commands to aspirator arm subsystem software through an API to trigger various aspiration steps and processes. Such steps can processes can include, for example, mapping system component locations, actuating vacuum sources, setting and controlling flow rates, and fluid removal device movement while aspirating, such as controlling a sweeping motion of the fluid removal device across x and y dimensions defined for the relative plate or other well device definitions used. Precise motions and speeds of the fluid removal device can be controlled for by the software of such automated systems, as well as various other aspects of aspiration operations.

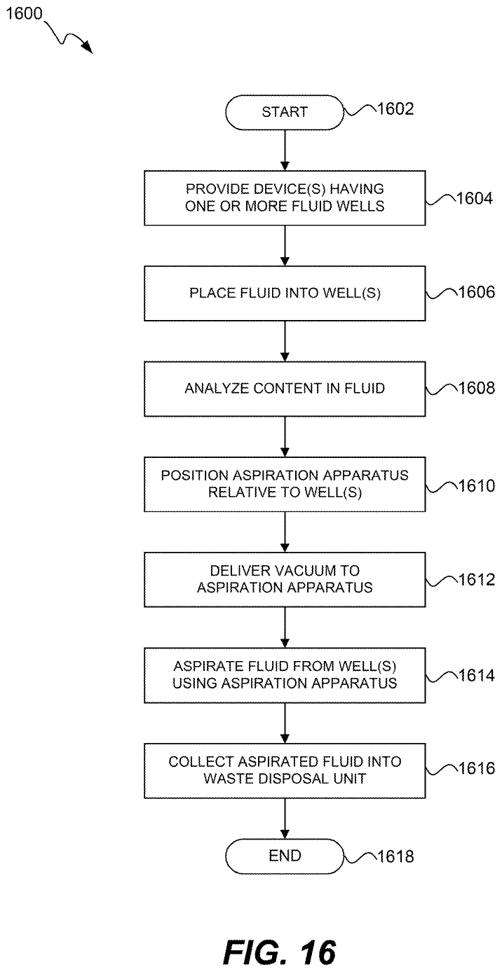

FIG. 16 presents a flowchart of an example method of processing fluid samples. Such processing can involve the detection, identification and quantification of small molecules and macromolecules, although other fluid processing applications are also possible. In various embodiments, method 1600 can be applied using the various systems, modules, apparatuses and features provided above, and can include some or all of the various steps set forth in method 1500 and/or method 1550 above. After a start step 1602, a first process step 1604 can involve providing one or more devices having a plurality of wells configured to hold fluid therein.

At the next process step 1606, fluid can be placed into the wells. As noted above, this can be performed automatically by way of, for example, a pipette system that can be robotically controlled, such as by a robotic arm that is automatically operated by a software program on an associated computer.

At a following process step 1608, content within the fluid in the plurality of the wells can be analyzed. This can take place using any of various well-known fluid analysis procedures. Fluid can be analyzed, for example, for the presence of and characteristics of various molecules and macromolecules. Analyzing fluid content can be accomplished, for example, by way of applying a voltage to electrodes that are in the wells, and then observing characteristics of the fluid as a result, as will be readily appreciated.

At the next process step 1610, an aspiration apparatus can be positioned relative to the plurality of wells. Such an aspiration apparatus can be any of the apparatuses and components disclosed above in any suitable combination, such as an apparatus arm, manifold component, vacuum conduit, pipettes, and the like.

At a following process step 1612, a vacuum can be delivered to the aspiration apparatus. In some arrangements, a pump or vacuum source may keep a constant vacuum applied to the aspiration apparatus and/or associated components. In other arrangements, the pump or vacuum source may be activated, paused, and then reactivated as part of a manual or an automated process where the aspiration apparatus is moved from one set of wells to another set of wells to aspirate fluid from different sets of wells at different times.

At the next process step 1614, the fluid can be aspirated from the wells using the aspiration apparatus. This can involve performing one or more steps from one or both of methods 1500 and 1550 above, for example.

At subsequent process step 1616, aspirated fluid can be collected into a waste disposal unit. This can involve the fluid being completely removed from the wells and aspiration apparatus and passed through one or more pneumatic connections to an external box having a removable waste disposal unit, as set forth above. The method then ends at end step 1618.

It will be appreciated that each of the foregoing methods may include additional steps not shown, and that not all steps are necessary in some embodiments. For example, additional steps may include imaging, as well as installing and operating an external box. Other process steps can involve multiple cycles of placing fluid and aspirating fluid prior to analyzing fluid content of a fluid of interest, such as during a buffer or flush cycling process. Furthermore, the order of steps may be altered as desired, and one or more steps may be performed simultaneously. For example, process steps 1612 through 1616 may be performed simultaneously in some arrangements. In various arrangements, some or all process steps may all be automatically performed by a robotic system.

Although the foregoing disclosure has been described in detail by way of illustration and example for purposes of clarity and understanding, it will be recognized that the above described disclosure may be embodied in numerous other specific variations and embodiments without departing from the spirit or essential characteristics of the disclosure. Certain changes and modifications may be practiced, and it is understood that the disclosure is not to be limited by the foregoing details, but rather is to be defined by the scope of the appended claims.

What is claimed is:

1. An apparatus configured for the removal of fluids within a fluid sample processing system, the apparatus comprising:
an aspiration arm configured to facilitate the delivery of a vacuum to one or more devices arranged into one or more rows, the one or more devices including one or more wells configured to hold fluid therein;
a first manifold component coupled to the aspiration arm, wherein the first manifold component includes a first set of multiple fluid transmitting extensions configured to be inserted simultaneously into a first set of the one or more wells; and
a vacuum conduit coupled to the first manifold component, wherein the vacuum conduit is configured to deliver vacuum to and aspirate fluid from the one or more wells.

2. The apparatus of claim 1, wherein the vacuum conduit includes a flexible tube coupled to a vacuum source located outside the apparatus.

3. The apparatus of claim 1, wherein the aspiration arm includes one or more fluid passages located within the aspiration arm, the one or more fluid passages being configured to deliver vacuum from the vacuum conduit to the manifold component and transmit fluids from the manifold component into the vacuum conduit.

4. The apparatus of claim 3, wherein the one or more fluid passages are integrally formed within a flanged portion of the aspiration arm.

5. The apparatus of claim 1, wherein the first set of multiple fluid transmitting extensions form a set of pipettes.

6. The apparatus of claim 1, further comprising:
a coupling arrangement configured to removably couple the first manifold component to the aspiration arm, wherein the coupling arrangement is further configured to secure the first manifold component in place with respect to the aspiration arm.

7. The apparatus of claim 6, wherein the coupling arrangement is further configured to allow the first manifold component to be replaced with a second manifold component having a second set of multiple fluid transmitting extensions configured to be inserted simultaneously into the first set of the one or more wells, wherein the second set of multiple fluid transmitting extensions have dimensions that are different than the dimensions of the first set of multiple fluid transmitting extensions.

8. The apparatus of claim 1, wherein the apparatus is configured to be moved such that the first set of multiple fluid transmitting extensions can be simultaneously removed from the first set of the one or more wells and can be inserted simultaneously into a second set of the one or more wells.

9. The apparatus of claim 1, wherein the apparatus is configured to be manually operated with respect to the one or more wells.

10. The apparatus of claim 1, wherein the apparatus is configured to be robotically operated with respect to the one or more wells, and further comprising:
one or more coupling features, wherein the one or more coupling features are configured to couple the aspiration arm to a fluid handling robot of the fluid sample processing system.

11. The apparatus of claim 1, further comprising:
a first set of pipette tips configured to be removably coupled to the first set of multiple fluid transmitting extensions, wherein the first set of pipette tips are further configured to be inserted simultaneously into the first set of the one or more wells.

12. The apparatus of claim 1, wherein the aspiration arm includes a base component rotationally coupled to a pivot component such that the base component is configured to rotate along a longitudinal axis with respect to the pivot component.

13. The apparatus of claim 12, wherein the pivot component is coupled to the first manifold component and the base component includes one or more coupling features configured to couple the base component to a fluid handling robot of the fluid sample processing system.

14. The apparatus of claim 13, wherein the pivot component is rotationally coupled to the first manifold component and is configured to rotate along a horizontal axis that is orthogonal to the longitudinal axis.

15. The apparatus of claim 14, wherein the first manifold component includes a pipette tip component, a middle component, and a base component, the base component being coupled to the pivot component of the aspiration arm.

16. The apparatus of claim 15, wherein one or more fluid passages are located within each of the pipette tip component, middle component, and base component, the one or more fluid passages being configured to deliver vacuum from the vacuum conduit to external openings at tips of the pipette tip component and transmit fluids from the external openings into the vacuum conduit.

17. A method of processing fluid samples, the method comprising:
providing one or more devices arranged into one or more rows, the one or more devices including one or more wells configured to hold fluid therein;
placing a fluid into the top or tops of the one or more wells; and
aspirating the fluid from the top or tops of the plurality of wells using an aspiration apparatus, wherein the aspiration apparatus includes an aspiration arm, a manifold component coupled to the aspiration arm, and a vacuum conduit configured to deliver a vacuum to the aspiration apparatus and transmit the fluid from the aspiration apparatus.

18. The method of claim 17, wherein the manifold component includes a first set of multiple fluid transmitting extensions configured to be inserted simultaneously into a first set of multiple wells from the one or more wells.

19. The method of claim 17, wherein the placing and the aspirating are automatically performed by one or more robotic systems.

20. The method of claim 17, further comprising the steps of:
analyzing content in the fluid within the one or more wells; and
collecting the aspirated fluid into a waste disposal unit.
